(19) United States
(12) Patent Application Publication
(10) Pub. No.: US 2011/0141099 A1
(43) Pub. Date: Jun. 16, 2011

(54) DRIVING METHOD FOR PIXELS OF BISTABLE DISPLAY

(75) Inventor: Ying-Chuan CHENG, Hsinchu City (TW)

(73) Assignee: E Ink Holdings Inc., Hsinchu (TW)

(21) Appl. No.: 12/838,148

(22) Filed: Jul. 16, 2010

(30) Foreign Application Priority Data
Dec. 15, 2009 (TW) 098142972

(51) Int. Cl. G06F 3/038

(52) U.S. Cl. 345/214

(57) ABSTRACT

A driving method for pixels of bistable display is adapted into a bistable display having a plurality of pixels. The driving method comprises: increasing predetermined driving forces of the pixels to increased driving forces in a predetermined period; employing the increased driving forces to drive the pixels in the predetermined period respectively; and employing the predetermined driving forces configured for driving the pixels to drive the pixels out of the predetermined period respectively.

### CROSS-REFERENCE TO RELATED APPLICATIONS

This application is based upon and claims the benefit of priority from the prior Taiwan Patent Application No. 098142972, filed Dec. 15, 2009, the entire contents of which are incorporated herein by reference.

### BACKGROUND

1. Field of the Invention

The present invention relates to a flat display, and more particularly to a driving method for pixels of a bistable display.

2. Description of the Related Art

With the rapid development of the display technology, flat display has been widely applied into various display fields. Bistable display has many advantages, such as low power consumption, high reflectivity and high contrast ratio, etc., so that it has been an important flat display.

Refer to FIG. 1, which is a cross-sectional schematic view of a conventional bistable display. As shown in FIG. 1, the bistable display 10 may be an electrophoretic display having a plurality of pixels, such as a microcapsule electrophoretic display. In detail, the bistable display 10 includes substrates 11, 12, and an electrophoretic layer 13 intersected between the two substrates 11, 12. The electrophoretic layer 13 has a plurality of microcapsules 14, and each of the microcapsules 14 has a dielectric solvent 16 filled therein and charged pigment particles 17 distributed in the dielectric solvent 16. The bistable display 10 is divided into a plurality of pixels by data lines and scan lines (not shown) disposed on one of the substrates 11, 12 which are intersected with each other. Each of the pixels respectively employs voltage differences between a common electrode and a pixel electrode disposed on the substrates 11, 12 respectively, to drive the charged pigment particles 17 in the dielectric solvent 16, such that each of the pixels represents corresponding grays and the bistable display 10 displays frames. The technology is obvious for persons skilled in the art, and is not described herein.

A conventional driving method for the pixels of the bistable display 10 is driving each of the pixels according to a predetermined driving list. The predetermined driving list defines a plurality of driving values corresponding to drive each of the pixels in various conditions, and each of the driving values corresponds to a predetermined driving force respectively. Then according to the predetermined driving force, a corresponding data potential is supplied to a corresponding pixel electrode of each of the pixels and a corresponding common potential is supplied to a corresponding common electrode thereof, such that a voltage difference between the data potential and the common potential of two ends of each of the pixels is employed to supply the predetermined driving force to each of the pixels. Therefore each of the pixels represents a corresponding gray respectively to display a frame on the bistable display.

However, in the conventional driving method for the pixels of the bistable display 10, since the charged pigment particles 17 are distributed in the dielectric solvent 16, and the dielectric solvent 16 is viscous to limit a moving speed of the charged pigment particles 17, the conventional driving method for the pixels of the bistable display 10 displays frames slowly, and more particularly a switching speed of the frames is very slow.

### BRIEF SUMMARY

The present invention relates to a driving method for pixels of bistable display, which can efficiently improve a frame-switching speed of the bistable display.

A driving method for pixels of bistable display is adapted into a bistable display having a plurality of pixel. The bistable display drives the pixels according to a driving list, and the driving list defines a plurality of driving values corresponding to one of the pixels in various conditions. The driving values correspond to predetermined driving forces respectively, and the predetermined driving forces are voltage differences between data potentials and common potentials of the pixels respectively. The driving method of the pixels of the bistable display comprises increasing the predetermined driving forces corresponding to the driving values respectively to be increased driving forces in a predetermined period; employing the increased driving forces to drive the pixels respectively which are originally driven by the predetermined driving forces in the predetermined period; and driving the pixels by the predetermined driving forces corresponding to each of the driving values respectively out of the predetermined period.

In an exemplary embodiment of the present invention, the step of increasing the predetermined driving forces corresponding to the driving values respectively to be the increased driving forces in the predetermined period, comprises altering the data potentials provided to the pixels to increase the voltage differences between two terminals of the pixels respectively.

In an exemplary embodiment of the present invention, the step of increasing the predetermined driving forces corresponding to the driving values respectively to be the increased driving forces in the predetermined period, comprises altering the common potentials provided to the pixels to increase the voltage differences between two terminals of the pixels respectively when the increased driving forces for driving the pixels in a same frame are increased in a same direction with each other. The increased driving forces for driving the pixels are increased in a negative direction or in a positive direction.

The driving method for the pixels of the bistable display of the present invention increases the driving forces for driving each of the pixels, to accelerate the gray-switching speed of each of the pixels, and accelerate the frame-switching speed of the bistable display.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a cross-sectional schematic view of a conventional bistable display.

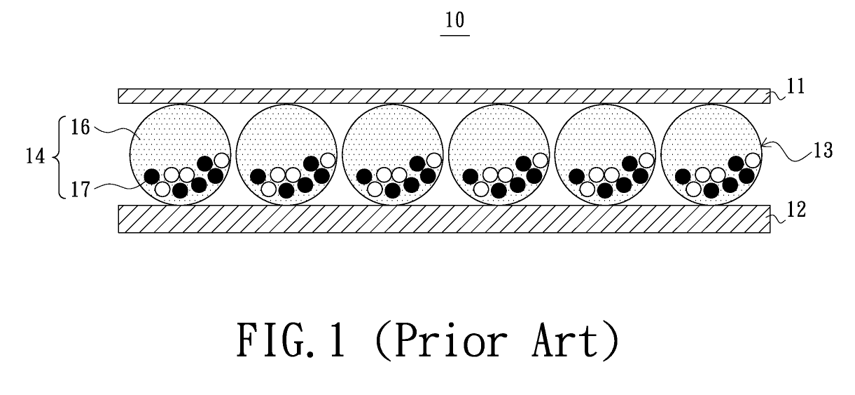

FIG. 2 is a flow chart of a driving method for pixels of bistable display in accordance with an exemplary embodiment of the present invention.

### DETAILED DESCRIPTION

Reference will now be made to the drawings to describe exemplary embodiments of the present driving method for pixels of bistable display in detail. The following description is given by way of example, and not limitation.

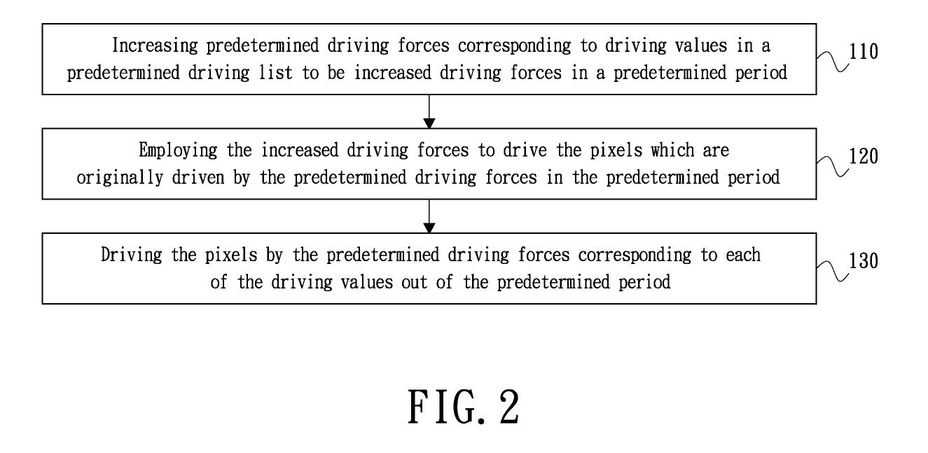

Refer to FIG. 2, which is a flow chart of a driving method for pixels of bistable display in accordance with an exemplary embodiment of the present invention. The bistable display of the exemplary embodiment of the present invention may be an electrophoretic display, such as a microcapsule electrophoretic display 10 having a plurality of pixels. The bistable display 10 drives each of the pixels of the bistable display 10 according to a predetermined driving list. The predetermined driving list defines a plurality of driving values for driving each of the pixels in various conditions, and each of the driving values corresponds to a predetermined driving force respectively.

The driving method for the pixels of the bistable display in accordance with the exemplary embodiment of the present invention includes following steps. Firstly, a step 110 is performed. That is, the predetermined driving forces corresponding to the driving values in the predetermined driving list are increased to be increased driving forces in a predetermined period. Then, a step 120 is performed. That is, the increased driving forces are employed to drive the pixels which should be driven by the predetermined driving forces in the predetermined period. Finally, a step 130 is performed. That is, the pixels are driven by the predetermined driving forces corresponding to each of the driving values respectively out of the predetermined period.

In detail, when the bistable display 10 needs to display a frame, more particularly, when the bistable display 10 needs to be switched from a first frame to a second frame, each of the pixels of the bistable display 10 needs to be switched from a first gray corresponding to the first frame to a second gray corresponding to the second frame. At this moment, the bistable display 10 will find out driving values needed by each of the pixels, and find out corresponding predetermined driving forces in the predetermined driving list. The predetermined driving forces are predetermined voltage differences between predetermined data potentials to pixel electrodes of the pixels and predetermined common potentials to common electrodes of the pixels. In the exemplary embodiment of the present invention, the predetermined common potentials to the common electrodes of each of the pixels of the bistable display 10 are all a best set potential provided by manufacturers of the bistable display 10, such as −1.xV. The predetermined data potentials to the pixel electrodes of each of the pixels of the bistable display 10 correspond to the corresponding predetermined driving forces respectively. For example, when one pixel of the bistable display 10 is switched from the first gray to the second gray, if the predetermined driving force thereof is +15V, the predetermined data potential to the pixel electrode of the pixel is +15V (assuming the predetermined common potential is 0V).

For increasing the predetermined driving forces in the predetermined period to obtain the increased driving forces, it may alter the predetermined data potentials of each of the pixels, or alter the predetermined common potentials of each of the pixels, to increase the predetermined driving forces of each of the pixels. For example, when one pixel of the bistable display 10 is switched from the first gray to the second gray, if the predetermined driving force is +15V, it may keep the common potential of the pixel in the best set potential −1.xV and increase the data potential of the pixel to be +20V to increase the corresponding predetermined driving force of the pixel. Of course, the driving method of the exemplary embodiment of the present invention may keep the data potential of the pixel in +15V and alter the common potential of the pixel to be −5V, to increase the voltage difference between two terminals of the pixel for obtaining the increased driving force.

Since the common electrodes of each of the pixels of the bistable display 10 are generally be electrically coupled together and receive a same common potential, it is obvious for persons skilled in the art that when the exemplary embodiment of the present invention alters the predetermined common potentials of each of the pixels to increase the predetermined driving forces of each of the pixels, the increased driving forces for driving each of the pixels are all increased in a same direction in the predetermined period, such as in a negative direction or in a positive direction. Therefore, it can avoid a condition that the predetermined driving forces of some pixels are increased and the predetermined driving forces of other pixels are decreased when altering the common potentials to the common electrodes of each of the pixels.

In summary, the driving method for the pixels of the bistable display of the exemplary embodiment of the present invention increases the predetermined driving forces to be the increased driving forces and employs the increased driving forces to drive each of the pixels in the certain predetermined period when each of the pixels of the bistable display is switched from the first gray corresponding to the first frame to the second gray corresponding to the second frame. Because the increased driving forces have a stronger driving capability, the increased driving forces can accelerate the switch speed of each of the pixels switched from the first gray to the second gray. Then the predetermined driving forces are employed to drive each of the pixels such that each of the pixels can stably display the second gray. Therefore, the driving method for the pixels of the bistable display of the exemplary embodiment of the present invention can accelerate the gray-switching speed of each of the pixels, thus it also can accelerate the frame-switching speed of the bistable display.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A driving method for pixels of bistable display being adapted into a bistable display having a plurality of pixels, the bistable display driving the pixels according to a driving list, the driving list defining a plurality of driving values for driving one of the pixels in various conditions, the driving values corresponding to predetermined driving forces respectively, the predetermined driving forces being voltage differences between data potentials and common potentials of the pixels respectively; the driving method for the pixels of the bistable display comprising:
increasing the predetermined driving forces corresponding to the driving values respectively to be increased driving forces in a predetermined period;
employing the increased driving forces to drive the pixels respectively which are originally driven by the predetermined driving forces in the predetermined period; and
driving the pixels by the predetermined driving forces corresponding to each of the driving values respectively out of the predetermined period.

2. The driving method for the pixels of the bistable display as claimed in claim 1, wherein the step of increasing the predetermined driving forces corresponding to the driving values respectively to be the increased driving forces in the predetermined period, comprises:
altering the data potentials provided to the pixels to increase the voltage differences between two terminals of the pixels respectively.

3. The driving method for the pixels of the bistable display as claimed in claim 1, wherein the step of increasing the predetermined driving forces corresponding to the driving values respectively to be the increased driving forces in the predetermined period, comprises:
altering the common potentials provided to the pixels to increase the voltage differences between two terminals of the pixels respectively when the increased driving forces for driving the pixels in a same frame are increased in a same direction with each other.

4. The driving method for the pixels of the bistable display as claimed in claim 3, wherein the increased driving forces for driving the pixels are increased in a negative direction.

5. The driving method for the pixels of the bistable display as claimed in claim 3, wherein the increased driving forces for driving the pixels are increased in a positive direction.
